(19) United States
(12) Patent Application Publication
(10) Pub. No.: US 2004/0131417 A1
(43) Pub. Date: Jul. 8, 2004

(54) Connectors

(76) Inventors: Peter Clifford Green, Hamilton (NZ); Margaret Dulce Green, Hamilton (NZ)

Correspondence Address: JACOBSON HOLMAN PLLC, 400 SEVENTH STREET N.W., SUITE 600, WASHINGTON, DC, 20004, US

(21) Appl. No.: 10/445,303

(22) Filed: May 27, 2003

Related U.S. Application Data
(63) Continuation of application No. 10/253,986, filed on Sep. 25, 2002, now abandoned.
Application No. 10/253,986 is a continuation of application No. 10/059,275, filed on Jan. 31, 2002, now abandoned.
Application No. 10/059,275 is a continuation of application No. 09/749,238, filed on Dec. 26, 2000, now abandoned.
Application No. 09/749,238 is a continuation of application No. PCT/NZ99/00089, filed on Jun. 21, 1999.

(30) Foreign Application Priority Data
Jun. 24, 1998 (NZ) 330794

(51) Int. Cl. B25G 3/00; F16B 9/00

(52) U.S. Cl. 403/256

(57) ABSTRACT

The present invention relates to a connector for connecting a section of a first item to a section of a second item, the connector characterised in that the connector is capable of concertinaing in on itself on at least one side.

### TECHNICAL FIELD

This invention relates to improvements to connectors used to connect one item to another.

Preferred embodiments may relate to connection mechanisms wherein the items are parts of a fence. However, reference to fences should not be seen to limit the scope of the present invention's manufacture or use as the principles of the present intention may be applied to the connection of other items.

### BACKGROUND ART

In the past, many fences have been constructed of masonry or wood. However, recently the use of metal for fence construction is becoming more widespread. Such metal fence construction may comprise a metal frame with wire netting, or more commonly in domestic applications, lengths of metal bars and tubing arranged in an upright position between horizontal rails,

These uprights are commonly welded to the rails. The uprights may extend into the rail, or may pass partially or entirely through the horizontal rail. Sometimes the upright is welded or connected in some other fashion to the outside of the horizontal rail.

The problems with these methods of constructing fences are that welding techniques are labour intensive and are therefore expensive and time consuming. An experienced welder is required for the task which adds to the cost. Also welds can be unsightly.

Problems also exist when the ground is uneven. This is because the orientation of the fence uprights must be vertical with reference to the level, in order to effect the desired aesthetic qualities from a fence. This is a particular requirement in the case of domestic fence construction

Once a weld is made, it is very difficult to change the orientation of the upright relative to the rail. If therefore a fence is welded so that the uprights are not in a desired position, it is expensive and painstaking to correct the mistake.

Some methods have been developed to overcome these problems, which involve fitting expandable devices that clip into place when inserted into the rails. Previously, these have been only developed for use with circular shaped upright rails. These have been very effective in these applications. However, in markets, such as the United States, where rectangular and square shaped uprights are preferred, the consumer is not able to take advantage of the improved technology.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a connector for connecting one section of an item to a section of a second item,

the connector characterised in that the connector is capable of concertining in on itself on at least-one side.

Throughout this specification, reference to connecting may be made with reference to permanent connection, semi-permanent connection, releasable connections, moveable connections and so forth.

The term ‘concertina’ means in this specification capable of compressing or collapsing inwards.

In preferred embodiments however reference to connecting may be by way of semi-permanent connection. Reference to semi-permanent connection should not be seen to be limiting the scope of the present invention's manufacture or use as the principles of the present invention may be applied using other states of connection.

Reference to a first item may be hereafter made with reference to an upright element in a fence. The upright element may be a supporting post, an intermediate upright section, or some other upright arrangement.

Reference to the item as being a fence upright member should not be seen to be limiting the scope of the present invention, as the principles of the present invention may be applied to other items. For example, the present invention may be applied to burglar bars, ballustrading, scaffolding and for building other structures.

Throughout this specification, reference to a second item may be made with reference to a fence rail. Reference to a fence rail should not be seen to be limiting the scope of the present invention's manufacture or use, as other items may be used with the present invention.

The fence rail may include all or any parts of fence rails commonly used to construct fences.

Consequent upon the aforementioned definitions, the connecting of one item to a second item may be made with reference to the connection of a fence upright member to a fence rail.

The sections referred to on the fence rail may preferably be made with reference to an aperture in the underside of the rail.

The second item, being preferably the fence upright may engage the aperture in the fence rail by being inserted into, either wholly or partially, the fence rail aperture. The fence upright may pass partially or the entire way through the fence rail, the latter requiring an aperture on the top of the fence rail as well.

Reference to a section of the fence upright may be a section of the upright that is engaged with the first section. For example this may be the end of the section if the upright is not protruding all the way through the rail, or it may be a section of the tube or bar along its length, depending how far through the rail the upright is protruding.

Preferably there is included a first lockable fixing means that fixes the present invention to the first item.

This may be by way of a nut and bolt arrangement, adhesive, thread, bindings, or some other method.

Preferably, this may be by way of engaging the elongated concertinaed portion of the connector with an aperture in at least one side of the upright.

Preferably, there may be an aperture on either side of the upright, and there may be at least two concertinaed sections, which extend towards one another, which are commensurate with the apertures and the upright,

The above description should not be seen to be limiting, as other numbers of concertinaed sections and apertures may be used, depending on the nature of the application.

The lockable nature of the first fixing means is preferably by way of the outward flexural resistance of the connector against the edges of the apertures in the upright members. This resistance may retain the device in the desired position, but may be releasable if so desired.

There is preferably a second lockable fixing means that allows the connector to be attached to the second item, being the rail in the preferred embodiment.

For example this may be an adhesive arrangement, a nut and bolt arrangement by way of a threaded screw or some other arrangement.

In preferred embodiments, the second lockable fixing means may be the outward flexural resistance of the sides of the connector against the inside of the rail.

The flexural resistance need not be great, and may only be the resistance against the rail that is provided as a result of the connector being too large to fit through the aperture at the base or the top of the rail.

Preferably, the present invention may be manufactured from nylon. The advantage of using nylon is that it is resistant to corrosion and is easily manufactured.

The durability of the present invention will last a long time in its various applications in connecting fence systems together, particularly suiting harsh outdoor conditions.

However, the present invention may be manufactured from other materials, such as plastic, kevlar, wood, and so forth.

One embodiment of the present invention is envisaged to be a one piece loop that is concertinaed on itself on either side of the loop, so that inward portions of the loop project towards each other.

Other embodiments may not be a loop, but still configured with inward projections.

These inward projections fit tightly against the apertures in the upright, so that the present invention is looped around the upright. The upright is also positioned inside the rail and may provide a certain amount of outward flexural resistance against the sides of the rail to retain its position.

The position of the upright relative to the rail is maintained by the various lockable fig means, and the size of the device relative to the apertures in the rails.

The present invention provides a number of advantages over similar devices and previous methods of attaching fence rail systems.

Previously, such connectors involved a substantially circular piece in contact with the upright, with indents or apertures in the upright into which protruding members were extended. The device did not concertina on itself but relied an these protruding members which were attached to the inside of the rounded section.

The device worked in a similar fashion however, did not provide the advantages of the present invention.

By concertinaing the loop that fits around the upright, a greater surface area of contact is attainable between the concertinaed portion, which were formerly the projecting members in the prior art, with the sides of the apertures in the rails. This greater area of contact means that a more stable interaction is able to be achieved between the device and the upright.

The present invention is also able to be used with a variety of shaped rails. In particular, the present invention may be used very effectively with rectangular/square cross-sectional shaped steel tubing or bars, as well as being able to be configured for circular tubing or bars or any other shape including for example hexagonal cross-sections.

Likewise the present invention can be used with uprights of varying shapes—not just rectangular in cross-section, although this is a preferred use of the present invention.

This has an advantage over the prior art in that the prior art war only well suited to circular tubing or bars. Thus, the markets that prefer rectangular steel tubing or bars may take advantage of the present invention.

The present invention, by virtue of being a dosed curve about the upright, gives increased strength. Thus, if forces are applied to the fence in teems of torsion, bending and twisting, the present invention will withstand more of these activities than the prior art. The concertinaed sections that extend inwards towards each other also expand, to accommodate various sizes of apertures and therefore various sizes of uprights. Because the extensions may expand, any expansion of the rail or the upright due to heat expansion may be accommodated for without damage to the connection.

The present invention may be easily used to fix fences together, as they snap into place. There is also no need for welding, which greatly reduces costs, and also enables the contours of the ground to be followed while still achieving the correct aesthetic qualities of the fence and enabling errors to be corrected with relatively minimal effort.

The present invention is also of a size that is easily transported and packed, but is also constructed so that it may be manufactured for large or small applications.

### BRIEF DESCRIPTION OF DRAWINGS

Further aspects of the present invention will become apparent from the following description which is given by way of example only and with reference to the accompanying drawings in which;

FIG. 1 shows a cross-sectional view of the present invention, and

FIG. 2 shows a perspective view of the present invention in use, and

FIG. 3 and

FIG. 4 show two alternate embodiments of the present invention.

### BEST MODES FOR CARRYING OUT THE INVENTION

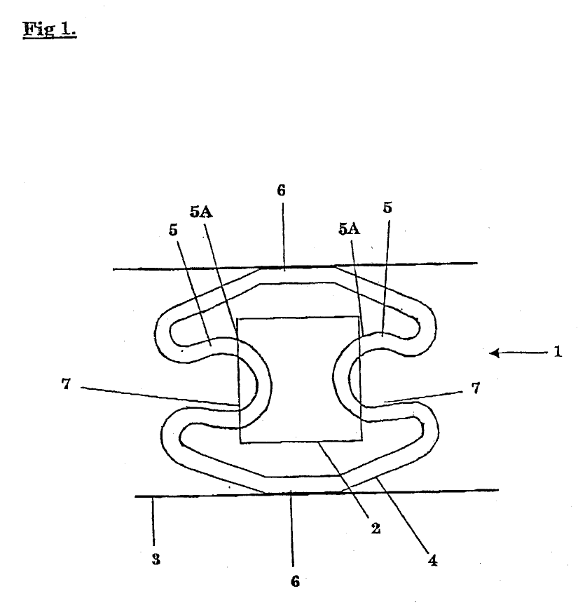

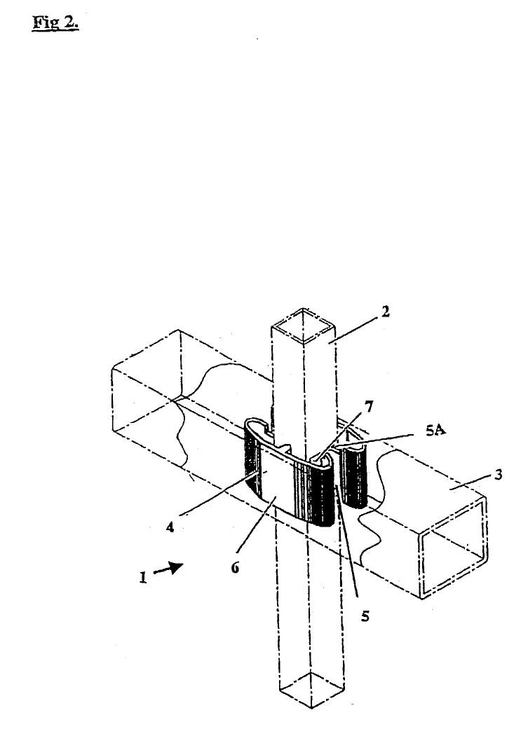

With reference to FIGS. 1 and 2 there is shown a connector (1) for connecting a fence rail (3) to a fence upright (92) has opposing apertures (7).

The connector (1) is one piece. Looped portions (4) include concertinaed projections (5) that protrude toward one another. The concertinaed projections (5) are held against the apertures (7) and the upright (2) by flexural forces against the surfaces of the aperture and the upright (2) at point (5A).

At point (6), the flat portions of the looped member (4) are held against the inside of the rail (3) by resistance forces caused by flexural resistance against the looped portion (4) being squashed.

In operation, the device (1) is inserted into the rail (3). The loop (4) is moved to a position over an aperture (9) in the rail. An upright member (2), with apertures (7) is inserted through the aperture in the rail not shown, so that the concertinaed projections (5) click into place into the apertures (7). The distance that the apertures (7) are placed on the upright will determine how far through the rail the upright (2) must protrude. It may require a further aperture on the top of the rail to enable the upright to protrude right through the width of the rail.

This provides a secure lockable means for connecting fence uprights with rails.

The upright may be released if the orientation is incorrect, or maybe angled slightly to correct any change in the contour of the ground. The present invention requires no welding or adhesive, and is strong, durable and easily assembles.

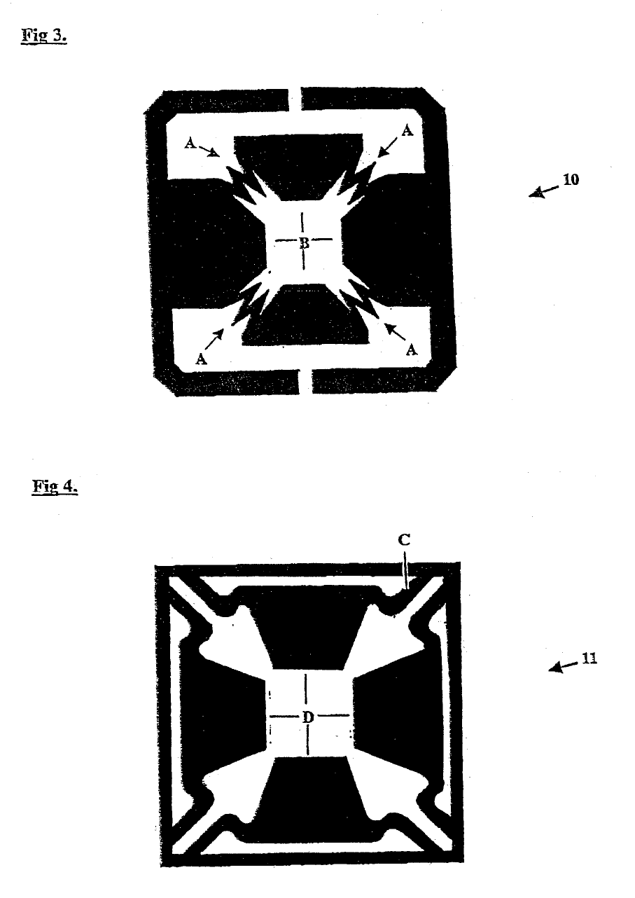

FIGS. 3 and 4 show alternate embodiments of the present invention.

FIG. 3 illustrates a connector (10) which can concertina inwards at points (A) to enable inward projections (B) to lock into apertures on a structural member such as a fence upright.

FIG. 4 is of a connector (11) which has flexible sections (C) which allow the inward projections (D) to lock in in a similar way to the connector (10).

Aspects of the present invention have been described by way of example only and it should be appreciated that modifications and additions may be made thereto without departing from the scope of the appended claims.

1. A connector for connecting a section of a first item to a section of a second item,
characterised in that the connector includes at least two concertina projections forming a first lockable fixing means and at least two flat portions forming a second lockable fixing means.

2. A connector as claimed in claim 1 wherein said connector is capable of concertinas on itself on at least two sides.

3. A connector as claimed in either claim 1 or claim 2 wherein the connector is fabricated of nylon.

4. A connector as claimed in either claim 1 or claim 2 wherein the said connector is fabricated of PVC.

5. A connector as claimed in any one of claims 1 to 5, wherein the connection is by way of a semi-permanent connection.

6. A connector as claimed in any one of claims 1 to 6, wherein the first item is a fence upright.

7. A connector as claimed in any one of claims 1 to 7, wherein the second item is a fence tail.

8. A connector as claimed in any one of claims 1 to 8, which is in one piece that is concertinaed on itself from either side of the loop so that inward portions of the connector project towards each other.

9. A connector as claimed in any one of claims 1 to 9, wherein the first item is rectangular in cross section.

10. A connector as claimed in any one of claims 1 to 10, wherein the second item is rectangular in cross section.

11. A structure including at least one connector as claimed in any one of the previous claims.

12. A structure as claimed in claim 12 wherein the structure is a fence assembly, the first section is a fence upright and the second section is a fence rail.

13. A method of building a structure using a connector as claimed previously, the method characterised in the steps of
a) inserting the connector into the aperture of a first item, and
b) moving the connector so that at least part of the looped member is positioned over an aperture in the first item, and
c) inserting a second item having apertures therein through the aperture in the fence rail, the second item being inserted to a position so that part of the connector protrudes into an aperture in the second item.

14. A connector substantially herein described with reference to and as illustrated by the accompanying drawings.

15. A structure substantially as herein described with reference to and as illustrated by the accompanying drawings.

16. A method of building a fence assembly substantially as herein described with reference to and as illustrated by the accompanying drawings.
